(19) United States
(12) Patent Application Publication
(10) Pub. No.: US 2026/0052492 A1
(43) Pub. Date: Feb. 19, 2026

(54) User Equipment Mobility Measurements

(71) Applicant: Apple Inc., Cupertino, CA (US)

(72) Inventors: Jie CUI, San Jose, CA (US); Dawei ZHANG, Saratoga, CA (US); Haitong SUN, Saratoga, CA (US); Hong HE, San Jose, CA (US); Manasa RAGHAVAN, Sunnyvale, CA (US); Qiming LI, Beijing (CN); Rolando E Bettancourt ORTEGA, Munich (DE); Xiang CHEN, Palo Alto, CA (US); Yang TANG, San Jose, CA (US); Yuexia SONG, Beijing (CN)

(21) Appl. No.: 19/103,055

(22) PCT Filed: Aug. 11, 2022
(86) PCT No.: PCT/CN2022/111598

§ 371 Date: Feb. 11, 2025

(51) Int. Cl. H04W 56/00; H04W 64/00; H04W 76/20

(52) U.S. Cl. CPC H04W 56/0015; H04W 64/00; H04W 76/20

(57) ABSTRACT

A user equipment (UE) in a connected mode, an inactive mode or an idle mode and configured to receive a synchronization signal block (SSB) based measurement timing configuration (SMTC) comprising an SMTC window based on a timing of a serving cell, adjust the SMTC window and measure an SSB burst of a target cell during the adjusted SMTC window.

### TECHNICAL FIELD

The present disclosure generally relates to wireless communication, and in particular, to user equipment mobility measurements.

### BACKGROUND

Air-to-ground (ATG) user equipment (UE) devices operating in ATG networks may experience different operating conditions than UEs operating in a typical ground based deployments. These operating include, but are not limited to, extremely large cell coverage ranges, flight speeds, coexistence between ATG and terrestrial networks, etc. To address these operating conditions there is a need for improved performance of ATG base stations (BSs) and UEs.

### SUMMARY

Some exemplary embodiments are related to a processor of a user equipment (UE) configured to receive a synchronization signal block (SSB) based measurement timing configuration (SMTC) comprising an SMTC window based on a timing of a serving cell, adjust the SMTC window and measure an SSB burst of a target cell during the adjusted SMTC window.

Other exemplary embodiments are related to a user equipment having a transceiver configured to communicate with a serving cell and a processor communicatively coupled to the transceiver and configured to receive a synchronization signal block (SSB) based measurement timing configuration (SMTC) comprising an SMTC window based on a timing of the serving cell, adjust the SMTC window and measure an SSB burst of a target cell during the adjusted SMTC window.

Still further exemplary embodiments are related to a processor of a base station operating as a serving cell for a user equipment (UE) in an air-to-ground (ATG) system. The processor is configured to receive an indication of a location parameter or a SFN (cell system frame number) and Frame Timing Difference (SFTD) measurement result from the UE, determine a location of a target cell for the UE, calculate a propagation difference in signals received from the serving cell and the target cell based on at least (i) the location parameter of the UE, a location of the serving cell and the location of the target cell or (ii) the SFTD measurement result, determine an adjustment to a synchronization signal block (SSB) based measurement timing configuration (SMTC) window based on at least the propagation difference and send, to the UE, an instruction comprising the adjustment to the SMTC window.

Additional exemplary embodiments are related to a base station operating as a serving cell for a user equipment (UE) in an air-to-ground (ATG) system. The base station has a transceiver configured to communicate with the UE and a processor communicatively coupled to the transceiver and configured to receive an indication of a location parameter or a SFN (cell system frame number) and Frame Timing Difference (SFTD) measurement result from the UE, determine a location of a target cell for the UE, calculate a propagation difference in signals received from the serving cell and the target cell based on at least (i) the location parameter of the UE, a location of the serving cell and the location of the target cell or (ii) the SFTD measurement result, determine an adjustment to a synchronization signal block (SSB) based measurement timing configuration (SMTC) window based on at least the propagation difference and send, to the UE, an instruction comprising the adjustment to the SMTC window.

### BRIEF DESCRIPTION OF THE DRAWINGS

FIG. 1 shows an exemplary network arrangement according to various exemplary embodiments.

FIG. 2 shows an exemplary air-to-ground (ATG) user equipment (ATG UE) according to various exemplary embodiments.

FIG. 3 shows an exemplary base station according to various exemplary embodiments.

FIG. 4 depicts a timing diagram according to existing embodiments of SMTC windows.

FIG. 5 depicts an exemplary radio resource control (RRC) signaling information element (IE) used to indicate the location of one or more target cells to the ATG UE according to various exemplary embodiments.

FIG. 6 depicts a first exemplary timing diagram for neighbor cell measurements according to various exemplary embodiments.

FIG. 7 depicts a second exemplary timing diagram for neighbor cell measurements according to various exemplary embodiments.

FIG. 8 depicts a third exemplary timing diagram for neighbor cell measurements according to various exemplary embodiments.

FIG. 9 depicts a fourth exemplary timing diagram for neighbor cell measurements according to various exemplary embodiments.

FIG. 10 depicts a fifth exemplary timing diagram for neighbor cell measurements according to various exemplary embodiments.

### DETAILED DESCRIPTION

The exemplary embodiments may be further understood with reference to the following description and the related appended drawings, wherein like elements are provided with the same reference numerals. The exemplary embodiments relate to improvements to ATG UEs and base stations. Specifically, adjustments to synchronization signal block (SSB) based measurement timing configuration (SMTC) windows to cover SSB bursts from neighboring cells when the ATG UE is performing neighbor cell measurements.

The exemplary embodiments are described with regard to an ATG UE. In the exemplary embodiments, it will be described that the ATG UE is installed on an aircraft. Those skilled in the art will understand that an ATG UE installed in aircraft may be used for any number of purposes. For example, the ATG UE may be used as an alternative manner of communicating with the aircraft other than the normal air traffic control (ATC) channels. In another example, the ATG UE may act as a relay for UEs on board the aircraft so passengers may use their UEs on a flight. However, reference to an ATG UE and installation on an aircraft is merely provided for illustrative purposes. The exemplary embodiments may be utilized with any electronic component that may establish a connection to a network and is configured with the hardware, software, and/or firmware to exchange information and data with the network. Therefore, the ATG UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network that assigns, in an unsecured manner, an identifier to a device that is using the network.

Existing big cell coverage areas in ATG deployments may cause substantial impact to measurement configurations and behavior for ATG UEs. Serving and target base stations (e.g., gNBs) may be separated by distances of hundreds of kilometers, with round trip times for signaling being potentially up to 2 ms (or more).

The problems facing ATG systems differ from existing satellite systems from the UE perspective. These differences include ATG UE knowledge (or lack thereof) of the location of the base stations and the ATG UEs capability related to a Global Navigation Satellite System (GNSS). Mobility measurements and cell change accuracy may be improved by ATG UE support of GNSS.

Existing terrestrial network system designs use synchronization signal block (SSB) based measurement timing configuration (SMTC) windows of 1/2/3/4/5 ms. Due to the different SSB numbers in the SSB burst, existing SMTC windows can cover the SSB to perform measurements.

However, in ATG systems, the propagation distance can be up to 2 ms from the serving to the neighbor cell. In a hypothetical example, consider an ATG UE positioned 300 km from both the serving gNB and target gNB. In this example, the ATG UE is at the vertex point of the isosceles triangle formed by itself and the two gNBs. Signals propagating from either the serving gNB or target gNB must first travel to the ATG UE before reaching their respective target gNB. The total signal distance traveled is 600 km (300 km+300 km) and the round trip time is (600 km/c)=2 ms. Thus, in ATG systems the existing SMTC window design cannot cover the target SSB burst from the target cell.

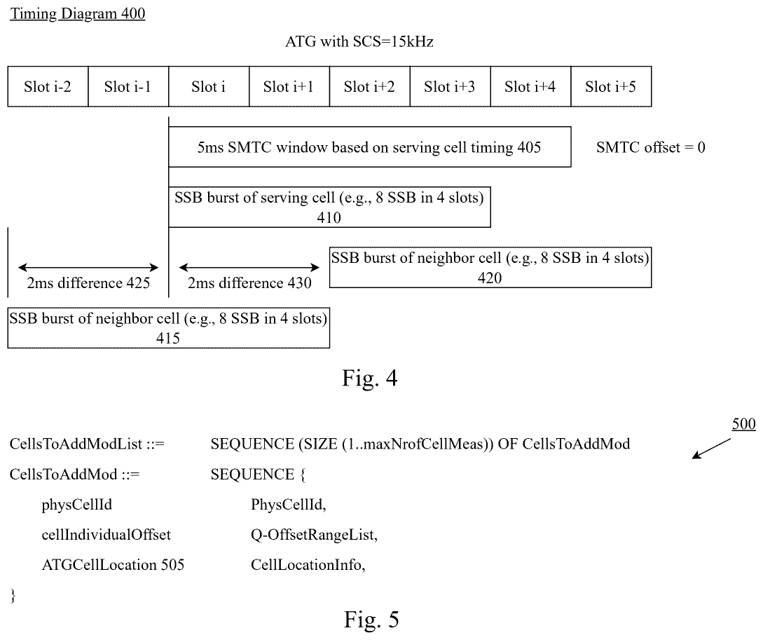

FIG. 4 depicts a timing diagram 400 according to existing embodiments of SMTC windows. The timing diagram 400 shows the issues related to the large time delay for ATG networks. In 405, a 5 ms SMTC window based on a serving cell's timing occurs (covering five slots beginning at slot I and terminating at slot i+4) to meet the 410 SSB burst of the serving cell. In 415, an SSB burst from a neighboring cell occurs at slot i−2 and continues to slot i+1 (covering four total slots). In 420, there is also an SSB burst identical to 415, except that it begins at slot i+2 and continues to slot i+5.

The 5 ms SMTC timing window 405 cannot cover the beginning of neighboring SSB burst 415 (caused by the 2 ms difference 425), nor can it cover the end of neighboring SSB burst 430 (caused by 2 ms difference 430). These 2 ms differences 420 and 430 are due to the finite nature of the speed of light. Thus, the existing SMTC windows may cause the ATG UE to miss SSB bursts from neighbor cells.

The exemplary embodiments redesign existing signal measurement windows based on the propagation time difference between the serving gNB and neighbor gNB(s) to account for the the large distances between the serving gNB and neighbor gNB(s). The exemplary embodiments are described in greater detail below.

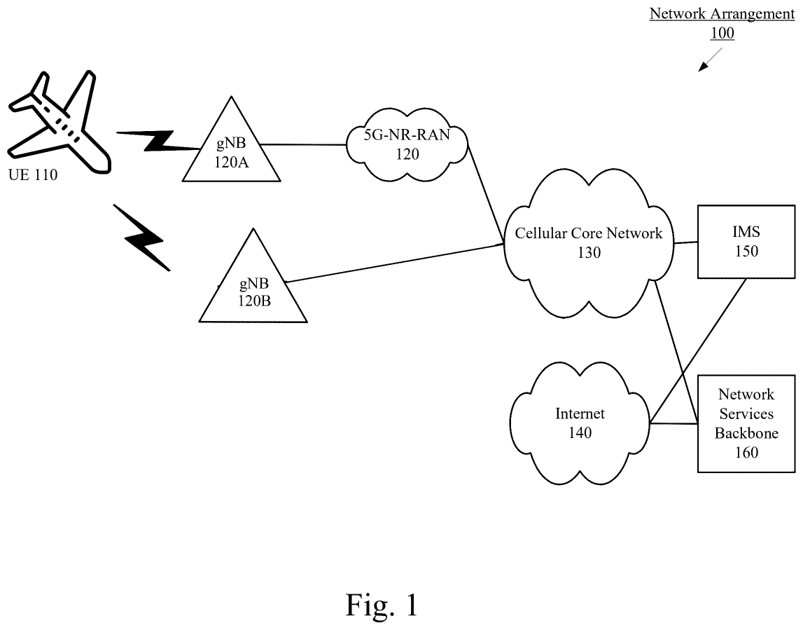

FIG. 1 shows an exemplary network arrangement 100 according to various exemplary embodiments. The exemplary network arrangement 100 includes an ATG UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. As described above, the exemplary embodiments are described with reference to an ATG UE 110 that is installed in an aircraft. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., LTE-RAN, wireless local area network (WLAN), 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120. The UE 110 may also have other chipsets to communicate with other types of RANs, e.g., LTE chipset, ISM chipset, etc.

The 5G NR RAN 120 may be a portion of a cellular network that may be deployed by a network carrier (e.g., Verizon, AT&T, T-Mobile, etc.). The 5G NR RAN 120 may include cells or base stations that are configured to send and receive traffic from UEs that are equipped with the appropriate cellular chip set. In this example, the 5G NR RAN 120 includes the gNB 120A and the gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks,

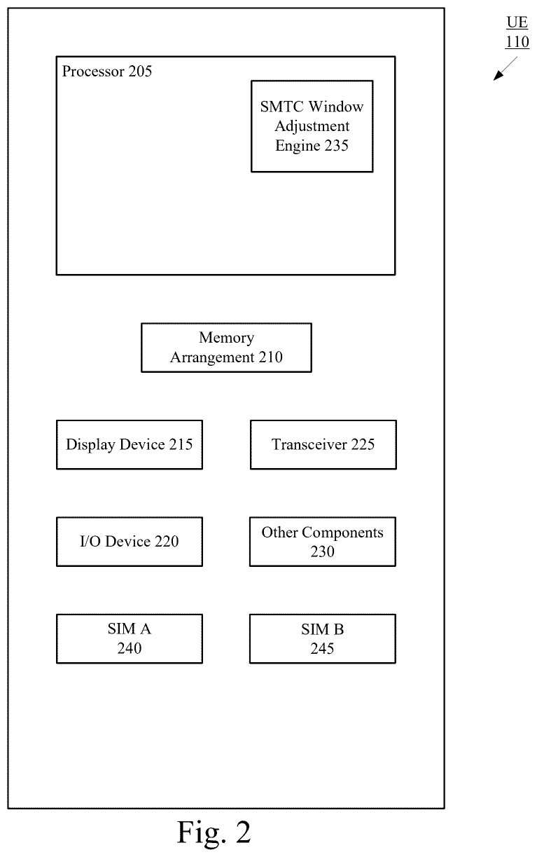

FIG. 2 shows an exemplary air-to-ground (ATG) user equipment (ATG UE) 110 according to various exemplary embodiments. The ATG UE 110 will be described with regard to the network arrangement 100 of FIG. 1. The ATG UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the ATG UE 110 to other electronic devices, sensors to detect conditions of the ATG UE 110, etc.

The processor 205 may be configured to execute a plurality of engines for the ATG UE 110. For example, the engines may include a SMTC window adjustment engine 235 for performing operations including reporting location information to a serving cell, determining a propagation difference between signals received from a serving cell and a neighbor cell, and adjusting the SMTC window to cover an SSB burst from the neighbor cell. These operations will be described in greater detail below.

The above referenced engine being an application (e.g., a program) executed by the processor 205 is only exemplary. The functionality associated with the engines may also be represented as a separate incorporated component of the ATG UE 110 or may be a modular component coupled to the ATG UE 110, e.g., an integrated circuit with or without firmware. For example, the integrated circuit may include input circuitry to receive signals and processing circuitry to process the signals and other information. The engines may also be embodied as one application or separate applications. In addition, in some ATG UEs, the functionality described for the processor 205 is split among two or more processors such as a baseband processor and an applications processor. The exemplary embodiments may be implemented in any of these or other configurations of an ATG UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies). For example, the transceiver 225 may operate on the unlicensed spectrum when e.g., NR-U is configured.

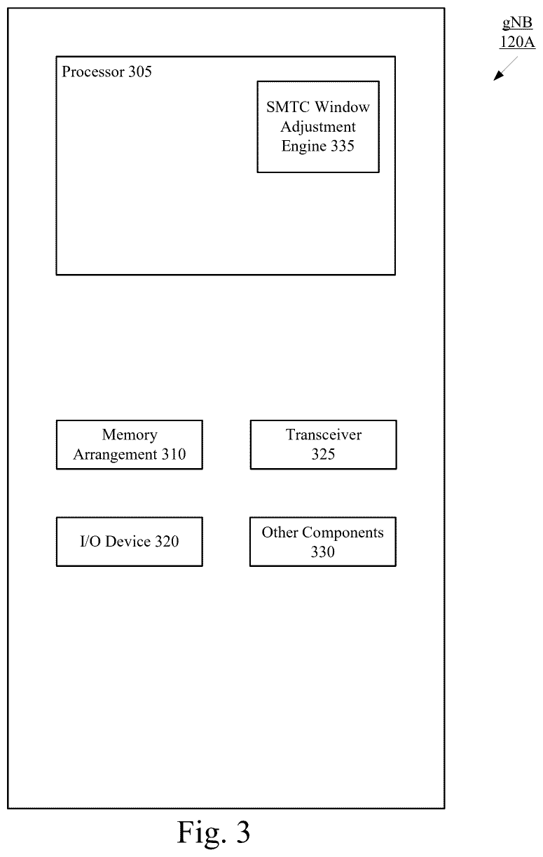

FIG. 3 shows an exemplary base station 300 according to various exemplary embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include an SMTC window adjustment engine 330 for performing operations including receiving location information from an ATG UE, determining a propagation difference between signals received by the UE from a serving cell and a neighbor cell, and adjusting the SMTC window to cover an SSB burst from the neighbor cell. These operations will be described in greater detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

The exemplary embodiments relate to adjustments to the SMTC timing window duration and offset to cover propagation delay differences for different conditions. Additional aspects of the exemplary embodiments include whether the ATG UE supports GNSS, whether the gNB location is known, whether the SMTC adjustments (including window duration and offset) are to be determined by the ATG UE or by the base station, and whether a cell-specific SMTC is used. Each of these exemplary embodiments are described in greater detail below.

When describing the exemplary embodiments, it is considered that the ATG system has an initial SMTC window of 5 ms based on the serving cell timing. However, it should be understood that the use of an initial SMTC window of 5 ms is only exemplary and the initial SMTC window may have a length that is less than or greater than 5 ms. In addition, in the examples provided below, it may be considered that the subcarrier spacing (SCS) is 15 kHz. Those skilled in the art will understand that the exemplary timing described below may change if the SCS is a different value and that the exemplary embodiments may be applied to ATG systems having a different SCS.

When describing the exemplary embodiments, it may be considered that the gNB 120A is the current serving cell and the gNB 120B is the neighbor cell or target cell. The terms neighbor cell and target cell may be used interchangeably. It should be understood that the use of a single neighbor cell is only exemplary and there may be multiple neighbor cells to a current serving cell. In addition, the target cell gNB 120B may be a serving cell for another UE and may therefore include the same functionality as the serving cell gNB 120A.

The exemplary embodiments include a cell-specific measurement object (MO) that is configured for the ATG DE (e.g., ATG UE 110). In this aspect, each cell or cell group may be configured in one MO, and a single SMTC configuration is applied for measurement on those cells. As will be described in greater detail below, the exemplary embodiments include options related to ATG UE based solutions or network based solutions.

In a first aspect, the SMTC configuration may be dependent upon the positioning capabilities (e.g., GNSS) of the ATG UE 110 and whether the ATG UE is aware of the neighbor cell locations, e.g., the location of the gNB 120B. In the following exemplary embodiments, it will be considered that the ATG UE 110 has GNSS capabilities (e.g., the ATG UE 110 knows its own location) and the is supplied with the locations of the neighbor cells.

With respect to the known locations of the neighbor cells, in some exemplary embodiments, a current serving cell may broadcast a neighbor cell list that includes locations for the neighbor cells in a given coverage area. In other exemplary embodiments, dedicated signaling (e.g., radio resource control (RRC) signaling) may be used to indicate the location of the target cell when the MO is configured for the ATG UE 110.

FIG. 5 depicts an exemplary radio resource control (RRC) signaling information element (IE) 500 used to indicate the location of one or more target cells to the ATG UE 110 according to various exemplary embodiments. In this example, the IE 500 includes an ATGCellLocation parameter 505 that includes CellLocation information 510. Thus, the serving cell (e.g., gNB 120A) may signal the ATG UE 110 the location of the neighbor cell (e.g., gNB 120A) that the ATG UE may use as will be described in greater detail below.

In the first aspect, a first option may be for an ATG UE 110 in an idle/inactive mode. In this first option, the ATG UE 110 may perform positioning to determine the location of the ATG UE 110. The ATG UE 110 may then calculate the propagation difference between the serving cell (e.g., gNB 120A) and the target cell (e.g., gNB 120B) based on the known locations of the ATG UE 110, the serving cell gNB 120A and target neighbor cell gNB 120B.

In this first option, the ATG UE 110 then determines how much time to offset the SMTC window based on both the configured SMTC window (based on serving cell timing) and the propagation difference between the serving cell gNB 120A and the target neighbor cell gNB 120B.

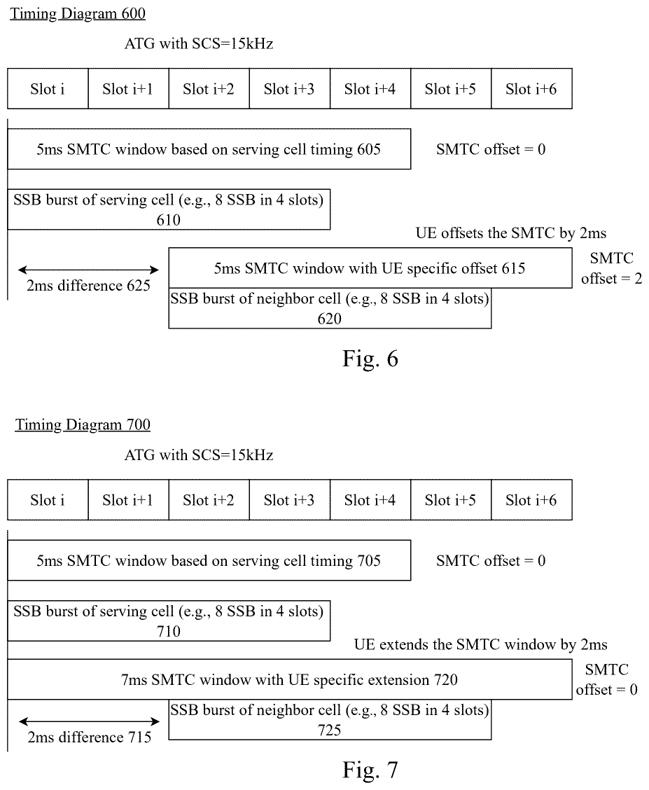

FIG. 6. depicts a first exemplary timing diagram 600 for neighbor cell measurements according to various exemplary embodiments. The timing diagram 600 illustrates the first option of the first aspect, e.g., the ATG UE 110 is in idle/inactive mode, supports GNSS and has received location information for the serving cell gNB 120A and neighbor cell 120B. The ATG UE 110 may have performed the propagation difference calculation described above. In this example, it may be considered that the propagation difference is 2 ms. However, this propagation difference is only exemplary and those skilled in the art will understand how to adjust the SMTC windows when the propagation difference has a different value than 2 ms based on the examples described below.

Initially, similar to the timing diagram 400, there may be an initial 5 ms SMTC window 605 based on the serving cell gNB 120A timing that covers five slots beginning at slot i and terminating at slot i+4 to overlap the SSB burst 610 of the serving cell gNB 120A in slots i to i+3. Thus, the SMTC window 605 may have an offset of 0 because it is based on the timing of the serving cell gNB 120A.

However, the ATG UE 110 may determine an offset for the SMTC based on the propagation difference calculation and the serving cell gNB 120A timing. In this example, the offset is 2 ms (equivalent to two slots). Thus, the timing diagram 600 shows the offset SMTC window 615 with a UE specific offset, e.g., from slot i+2 to slot i+6. Again, in this example, the offset is 2 ms based on the 2 ms propagation difference 625. In other examples, the offset may have a different value depending on the calculated propagation difference value. This UE specific offset allows the SMTC window 615 to completely cover the SSB burst 620 of the neighbor cell gNB 120B. This is in contrast to the example in timing diagram 400 where the SMTC window 405 did not completely cover the entirety of SSB bursts 415 and 420.

In the first aspect, a second option may also be for an ATG UE 110 in an idle/inactive mode. Again, in this second option, the ATG UE 110 may perform positioning to determine the location of the ATG UE 110. The ATG UE 110 may then calculate the propagation difference between the serving cell (e.g., gNB 120A) and the target cell (e.g., gNB 120B) based on the known locations of the ATG UE 110, the serving cell gNB 120A and target neighbor cell gNB 120B.

In the second option, instead of offsetting the SMTC window as in the first option, the ATG UE 110 may determine to extend the SMTC window duration. This extension may be based on two factors the configured SMTC window based on serving cell timing and the propagation difference between the serving cell 120A and the target cell 120B.

FIG. 7. depicts a second exemplary timing diagram 600 for neighbor cell measurements according to various exemplary embodiments. The timing diagram 700 illustrates the second option of the first aspect, e.g., the ATG DE 110 is in idle/inactive mode, supports GNSS and has received location information for the serving cell gNB 120A and neighbor cell 120B. The ATG UE 110 may have performed the propagation difference calculation described above. In this example, it may be considered that the propagation difference is 2 ms. However, this propagation difference is only exemplary and those skilled in the art will understand how to adjust the SMTC windows when the propagation difference has a different value than 2 ms based on the examples described below.

Again, similar to the timing diagrams 400 and 600, there may be an initial 5 ms SMTC window 705 based on the serving cell gNB 120A timing that covers five slots beginning at slot i and terminating at slot i+4 that overlaps the SSB burst 710 of the serving cell gNB 120A in slots i to i+3. Thus, the SMTC window 705 may have an offset of 0 because it is based on the timing of the serving cell gNB 120A.

In the second option, the ATG UE 110 may determine an extension for the SMTC window based on the propagation difference calculation and the serving cell gNB 120A timing. In this example, the extension is 2 ms (equivalent to two slots). Thus, the timing diagram 700 shows the SMTC window 720 that is extended from 5 ms to 7 ms, e.g., from slot i to slot i+6. Again, in this example, the extension is 2 ms based on the 2 ms propagation difference 715. In other examples, the offset may have a different value depending on the calculated propagation difference value. This UE specific offset allows the SMTC window 720 to completely cover the SSB burst 725 of the neighbor cell gNB 120B.

When the ATG UE 110 extends or offsets the SMTC window according to the first or second options, the ATG UE 110 may report this information to the serving cell gNB 120A via radio resource control (RRC) signaling, medium access control (MAC) signaling or layer 1 (L1) signaling.

In the first aspect, a third option may be for an ATG DE 110 in a connected mode. Again, the ATG UE 110 supports positioning capabilities, (e.g., GNSS), and the neighbor gNB locations are known to the ATG UE 110. First, while in the connected mode, the ATG UE 110 may utilize the above described first or second options of the first aspect (e.g., the UE based options) as shown by example and described above with respect to FIGS. 6 and 7. However, since the ATG UE 110 is communicating with the network when in the connected mode, the third option may be related to a network based solution where the network determines the offset and/or extension of the SMTC window and communicates this information to the ATG UE 110.

Initially, the UE 110 performs positioning to determine its location, and the ATG UE 110 reports its location, speed, and direction (e.g., GNSS information) back to the network (e.g., 5G NR-RAN 120) via the serving cell gNB 120A. This location reporting by the ATG UE 110 may be periodic or event triggered (e.g., when the MO is configured for the ATG UE 110, the ATG UE 110 will report its location to the network). Alternatively, the ATG UE 110 may measure system frame number (SFN) and Frame Timing Difference (SFTD) between the serving cell gNB 120A and neighbor cell gNB 120B and may report the SFTD measurements to the network via the serving cell gNB 120A.

Next, the serving cell may determine to extend or offset the SMTC timing window based on the location information provided by the ATG UE 110 and the locations of the serving cell gNB 120A and neighbor cell 120B. The serving cell gNB 120A may collect the target cell location information directly from the target cell 120B or from a location server. The calculation for determining the propagation difference was described above with the only difference being that the network (e.g., 5G NR RAN 120) is performing the calculation rather than the ATG UE 110. In other embodiments, the offset or extension of the SMTC window may be based on the SFTD measurement results received from the ATG UE 110.

In this third option, the network may configure the ATG UE 110 with the SMTC duration extension or SMTC window offset by RRC, MAC CE or L1 indication. In some exemplary embodiments, the configuration may be in the form of incrementing or decrementing the SMTC window duration (e.g., +1 ms, −1 ms, +2 ms, −2 ms, etc.) and/or incrementing or decrementing the SMTC window offset in the same manner.

Thus, in the third option, the network (via the serving cell gNB 120A) may slide the SMTC window to match the ATG UE 110 based on the ATG UE 110 location information and speed/directional information.

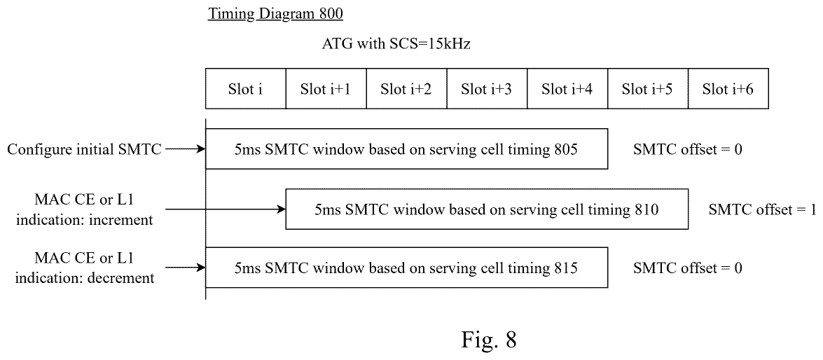

FIG. 8 depicts a third exemplary timing diagram 800 for neighbor cell measurements according to various exemplary embodiments. The timing diagram 800 illustrates the third option of the first aspect, e.g., the ATG UE 110 is in connected mode and supports GNSS. The ATG UE 110 may have reported its location parameters (e.g., location, speed, elevation, moving direction, etc.) or SFTD measurements to the serving cell gNB 120A. The network may have performed the propagation difference calculation or used the SFTD measurements to determine the SMTC window offset or extension value.

An initial SMTC window 805 based on the serving cell gNB 120A timing begins at slot i and runs for 5 ms (5 slots total). As described above, the network may determine an SMTC window offset or extension based on the information provided to the network by the ATG UE 110 (e.g., location parameters). In this example, the network has determined an offset of 1 ms. However, those skilled in the art will understand that an extension of 1 ms may be applied in a similar manner. The network via serving cell gNB 120A indicates to the ATG UE 110 via RRC, MAC CE or L1 to increment the SMTC window 1 slot forward (1 ms). Thus, the ATG UE 110 will apply the offset of +1 ms to result in the SMTC window 810 having the offset of 1 ms.

Similarly, at a later time, the network may calculate based on received ATG UE 110 location information and speed/directional information that the SMTC window should be decremented by 1 ms. Again, the serving cell gNB 120A indicates to the ATG UE 110 via RRC, MAC CE or L1 to decrement the SMTC window 1 slot backward (1 ms). Thus, the ATG UE 110 will apply the offset of −1 ms to result in the SMTC window 815 having the offset of 0 ms.

In a second aspect, the SMTC configuration may be dependent upon the ATG UE 110 not supporting positioning capabilities (e.g., GNSS) or the gNB locations are unknown to the ATG UE 110.

In a first option of the second aspect, the SMTC duration may be extended to Xms, where Xms is a period of time greater than 5 ms. The Xms may be a value that covers the SSB bursts of the neighbor cells based on the propagation difference. As described above, in some examples, the propagation difference may be 2 ms. Thus, the value of Xms may be selected to account for this propagation difference. As an example, the SMTC window may be extended by 3 ms to a fixed value of 8 ms for ATG operations. This length of time is only exemplary and any length of time greater than 5 ms may be used in this option.

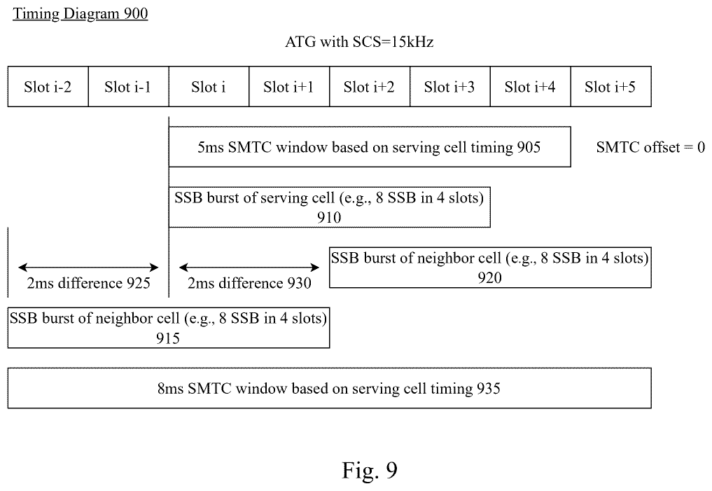

FIG. 9 depicts a fourth exemplary timing diagram 900 for neighbor cell measurements according to various exemplary embodiments. The timing 905-930 corresponds to the timing 405-430 of FIG. 4. However, the timing diagram 900 also shows the fixed value extended SMTC window 935. Again, in this example, the initial SMTC window 905 is extended by 3 ms to a total of 8 ms and is based on the serving cell gNB 120A timing. By extending the SMIC timing window a fixed quantity of time (e.g., 3 ms) the SMTC timing window now covers the SSB bursts 915 and 920 of the neighboring cells despite the 2 ms differences 925, 930 due to the propagation difference between the serving cell gNB 120A and the neighbor cell gNB 120B.

In a second option of the second aspect, the ATG UE 110 may search the neighboring cell SSB inside the whole SMTC window periodicity rather than the SMTC window.

In a third option of the second aspect, the ATG UE 110 may know its approximate moving trajectory. In this third option, the ATG UE 110 is unaware of the gNB locations but may be aware of the gNB order on its moving trajectory. The ATG UE 110 may perform the second option of the second aspect first, then upon identifying the SSB burst position, the ATG UE 110 may offset the SSB position based on its moving distance every SMTC periodicity or SSB burst periodicity.

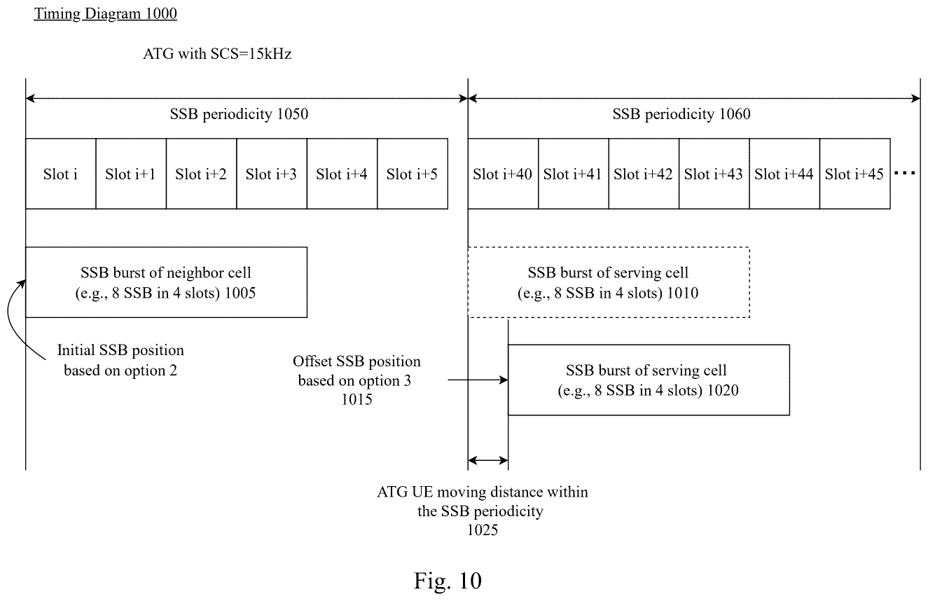

FIG. 10 depicts a fifth exemplary timing diagram 1000 for neighbor cell measurements according to various exemplary embodiments. The timing diagram 1000 illustrates the third option of the second aspect.

The timing diagram 1000 shows the SSB periodicity 1050. It is noted that FIG. 10 does not show slots i+6 through i+39 of the SSB periodicity 1050. An initial neighbor cell gNB 120B SSB burst 1005 begins at slot i. As described above, the first operation of the third option may be to use the second option where the ATG UE 110 searches for the neighbor cell SSB burst 1005 inside the whole SSB periodicity 1050 rather than simply the defined SMTC window.

Upon identification of the SSB burst position, the ATG UE 110 may offset 1015 the SSB position based on the moving distance 1010 every SSB periodicity. For example, as described above, the ATG UE 110 understands the gNB order along its moving trajectory. Once the ATG UE 110 detects the SSB burst 1005 during the first SSB periodicity 1050, the ATG UE 110 will know the timing for the SSB burst 1010 during the next SSB periodicity 1060. However, the ATG UE 110 will also know that this SSB burst 1010 will be offset by some value because of the propagation difference. Since the ATG UE 110 knows its trajectory and the approximate amount of movement 1025 within the SSB periodicity, the ATG UE 110 will have a general concept of how much the neighbor cell gNB 120B SSB burst 1010 will be offset, e.g., offset SSB burst 1020 that is offset by the offset amount 1015. The ATG UE 110 may then set the SMTC window based on this offset 1015 which should cover the neighbor cell gNB 120B offset SSB burst 1020.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to:
receive a synchronization signal block (SSB) based measurement timing configuration (SMTC) comprising an SMTC window based on a timing of a serving cell;
adjust the SMTC window; and
measure an SSB burst of a target cell during the adjusted SMTC window.

2. The processor of claim 1, wherein the UE is in one of a connected mode, an inactive mode or an idle mode.

3. The processor of claim 2, wherein the processor is further configured to:
determine a location of the UE;
receive an indication of a location of the serving cell and an indication of a location of the target cell;
calculate a propagation difference in signals received from the serving cell and target cell based on at least the location of the UE, the location of the serving cell and the location of the target cell.

4. The processor of claim 3, wherein the SMTC window is adjusted by an offset value based on at least the propagation difference.

5. The processor of claim 3, wherein the SMTC window is extended by an extension value based on at least the propagation difference.

6. The processor of claim 1, wherein the UE is in a connected mode and the processor is further configured to:
send an indication of a location parameter of the UE or a SFN (cell system frame number) and Frame Timing Difference (SFTD) measurement result to the serving cell;
receive, from the serving cell, an instruction to adjust the SMTC window.

7. The processor of claim 6, wherein the instruction is received in a radio resource control (RRC) message, a medium access control control element (MAC CE) or a layer 1 (L1) message.

8. The processor of claim 6, wherein the instruction comprises an indication to increment or decrement the SMTC window by a predetermined value.

9. The processor of claim 6, wherein the location parameter comprises a location, a speed, an elevation or a moving direction of the UE.

10. The processor of claim 6, wherein the location parameter is sent periodically or is triggered by the occurrence of an event.

11. The processor of claim 1, wherein the SMTC window is extended by a predetermined extension value.

12. The processor of claim 1, wherein the processor is further configured to:
search an entire SSB periodicity for an SSB burst of the target cell.

13. The processor of claim 12, wherein the processor is further configured to:
determine a trajectory of the UE including an order of target cells along the trajectory, wherein the SMTC window is adjusted based on at least the trajectory and a timing of the SSB burst.

14. The processor of claim 1, wherein the UE is an air-to-ground (ATG) UE.

15. A processor of a base station operating as a serving cell for a user equipment (UE) in an air-to-ground (ATG) system, the processor configured to:
receive an indication of a location parameter or a SFN (cell system frame number) and Frame Timing Difference (SFTD) measurement result from the UE;
determine a location of a target cell for the UE;
calculate a propagation difference in signals received from the serving cell and the target cell based on at least (i) the location parameter of the UE, a location of the serving cell and the location of the target cell or (ii) the SFTD measurement result;
determine an adjustment to a synchronization signal block (SSB) based measurement timing configuration (SMTC) window based on at least the propagation difference; and
send, to the UE, an instruction comprising the adjustment to the SMTC window.

16. The processor of claim 15, wherein the adjustment is an offset or an extension of the SMTC window.

17. The processor of claim 15, wherein the instruction is sent in a radio resource control (RRC) message, a medium access control control element (MAC CE) or a layer 1 (L1) message.

18. The processor of claim 15, wherein the instruction comprises an indication to increment or decrement the SMTC window by a predetermined value.

19. The processor of claim 15, wherein the location parameter comprises a location, a speed, an elevation or a moving direction of the UE.

20. The processor of claim 15, further configured to:
receive the location of the target cell from the target cell or a location server.
